(19) United States
(12) Patent Application Publication
(10) Pub. No.: US 2006/0194106 A1
(43) Pub. Date: Aug. 31, 2006

(54) Negative electrode plate for nickel-metal hydride storage battery, method for producing the same and nickel-metal hydride storage battery using the same

(75) Inventors: Soryu Nakayama, Atsugi-shi (JP); Soichi Shibata, Hirakata-shi (JP); Takashi Okawa, Fujisawa-shi (JP)

Correspondence Address: HAMRE, SCHUMANN, MUELLER & LARSON P.C., P.O. BOX 2902-0902, MINNEAPOLIS, MN, 55402, US

(73) Assignee: Matsushita Electric Industrial Co., Ltd., Kadoma-shi (JP)

(21) Appl. No.: 11/414,709

(22) Filed: Apr. 28, 2006

Related U.S. Application Data
(62) Division of application No. 10/411,647, filed on Apr. 11, 2003.

(30) Foreign Application Priority Data
Apr. 16, 2002 (JP) 2002-113010
Feb. 24, 2003 (JP) 2003-046455

(51) Int. Cl. H01M 4/58; H01M 4/62; B05D 5/12; B05D 1/36

(52) U.S. Cl. 429/218.2; 429/232; 427/123; 427/122; 427/404

(57) ABSTRACT

A negative electrode plate includes a conductive support and a first, a second and a third layer laminated on a surface of the support in this order from the support side. The first layer contains a hydrogen storage alloy powder and a first powder essentially made of a carbonaceous material. The second layer-contains a hydrogen storage alloy powder, the first powder and a second powder having conductivity. The third layer contains the second powder as a main component.

### CROSS REFERENCE TO RELATED APPLICATIONS

This application is a Division of application Ser. No. 10/411,647, filed 11 Apr. 2003, which application is incorporated herein by reference.

### BACKGROUND OF THE INVENTION

1. Field of the Invention

The present invention relates to a negative electrode plate for a nickel-metal hydride storage battery, a method for producing the same and a nickel-metal hydride storage battery using the same.

2. Description of the Related Art

Nickel-metal hydride storage batteries using a negative electrode containing a hydrogen-absorbing alloy are characterized in that they are environmentally friendlier and have higher energy density than conventional nickel-cadmium storage batteries. For this reason, nickel-metal hydride storage batteries are widely used as power sources for a variety of cordless equipment and electronic equipment, such as communications equipment and personal computers. Furthermore, nickel-metal hydride storage batteries also are used for electric tools and electric vehicles, for which charge and discharge at a large current are essential. Thus, nickel-metal hydride storage batteries are finding increasing applications, so that there is a demand for a nickel-metal hydride storage battery with higher performance.

In a nickel-metal hydride storage battery that is in a nearly fully charged or overcharged state, oxygen gas is generated at the positive electrode by the reaction represented by Formula (1):
OH⁻→½H₂O+¼O₂+e⁻ Formula (1)

The oxygen generated by this reaction passes through the separator to reach the negative electrode, and is consumed by reacting with hydrogen in a hydrogen-absorbing alloy contained in the negative electrode, as represented by the following Formulas 2 and 3.
½O₂+H₂O+2e⁻→2OH⁻ Formula (2)
MH+¼O₂→M+½H₂O Formula (3)

However, if the oxygen gas consumption reaction represented by Formulas (2) and (3) is not carried out promptly, the oxygen gas generation rate at the positive electrode exceeds the oxygen gas consumption rate at the negative electrode, so that the generated oxygen gas causes the internal pressure of the battery to increase. Then, when the internal pressure of the battery exceeds the operating pressure of the safety valve, the safety valve is actuated and the gas inside the battery is released, reducing the performance of the battery. Moreover, in the negative electrode of the nickel-metal hydride storage battery, the electrical contacts between particles of the hydrogen-absorbing alloy are likely to be insufficient and thus the conductivity tends to decrease. When the conductivity decreases, the ratio of the hydrogen-absorbing alloy particles that do not participate in charge/discharge increases, so that the internal pressure of the battery is likely to increase. Moreover, when the conductivity decreases, the high-rate charge and discharge characteristics also decrease. These problems are particularly evident when rapid charging is performed.

In order to suppress an increase in the internal pressure of the battery and thereby improving the conductivity of the negative electrode, a negative electrode including a carbon powder layer on its surface is proposed (see JP63-195960 A). In addition, a negative electrode including a mixed layer of a metal powder and a carbon powder on its surface also is proposed (see JP03-274664 A). In the case of these negative electrodes, the conductivity on the surface of the negative electrode has been increased, thereby facilitating the charging of the hydrogen-absorbing alloy on the surface. Moreover, the capability of the negative electrode to process oxygen gas is improved by the catalytic action of the carbon powder.

Also proposed is a negative electrode including on its surface a layer for suppressing oxidation that is made of hydrogen-absorbing alloy particles (core particles) coated with carbon particles (see JP63-195961 A). These particles promote the consumption of oxygen gas, since they have the effect of catalyzing oxygen consumption reaction and the effect of suppressing oxidation.

Further, a negative electrode including on its surface a layer made of a mixture of a metal-coated hydrogen-absorbing alloy powder and a carbon powder is also proposed (see JP63-055857 A).

However, at present, there is a demand for a negative electrode having higher oxygen consumption capability and higher conductivity.

### SUMMARY OF THE INVENTION

Therefore, with the foregoing in mind, it is an object of the present invention to provide a novel negative electrode plate for a nickel-metal hydride storage battery, a method for producing the same and a nickel-metal hydride storage battery using the same.

In order to attain the above-mentioned object, a negative electrode plate for a nickel-metal hydride storage battery according to the present invention includes a conductive support and a first, a second and a third layer arranged on a surface of the support in this order from the support side, wherein the first layer contains a hydrogen-absorbing alloy powder and a first powder essentially made of a carbonaceous material, the second layer contains the hydrogen-absorbing alloy powder, the first powder and a second powder having conductivity and the third layer contains the second powder as a main component.

Another negative electrode plate for a nickel-metal hydride storage battery according to the present invention includes a conductive support and an active material layer formed on both sides of the support, wherein the active material layer contains a hydrogen-absorbing alloy powder as a main component. A plurality of recesses is formed on a surface of the active material layer and a conductive layer containing a conductive powder as a main component is provided so as to cover the surface of the active material layer and to fill in the recesses.

A nickel-metal hydride storage battery according to the present invention includes either one of the above-described negative electrode plates of the present invention.

A method for producing a negative electrode plate for a nickel-metal hydride storage battery according to the present invention includes (i) applying a first slurry containing a hydrogen-absorbing alloy powder and a first powder essentially made of a carbonaceous material to both sides of a conductive support, followed by drying to form a first layer on both sides of the support; and (ii) spraying a second slurry containing a second powder having conductivity to the first layer.

Another method for producing a negative electrode plate for a nickel-metal hydride storage battery according to the present invention includes (I) applying a first slurry containing a hydrogen-absorbing alloy powder and a first powder essentially made of a carbonaceous material to both sides of a conductive support, followed by drying to form an active material layer on both sides of the support; (II) forming a plurality of recesses on a surface of the active material layer; and (III) applying a second slurry containing a second powder having conductivity to the active material layer.

As described above, with the negative electrode plate and the method for producing the same according to the present invention, it is possible to prevent an excessive increase in the internal pressure of a battery during overcharge and also to provide a negative electrode plate that can form a nickel-metal hydride storage battery with excellent large current charge and discharge characteristics. The use of this negative electrode plate can make it possible to provide batteries with high performance.

### BRIEF DESCRIPTION OF THE DRAWINGS

FIG. 1 is a schematic cross-sectional view showing an example of a negative electrode plate according to the present invention.

FIG. 2 is a schematic cross-sectional view showing another example of a negative electrode plate according to the present invention.

FIG. 3 is a schematic cross-sectional view showing still another example of a negative electrode plate according to the present invention.

FIG. 4A is a diagram showing an example of the arrangement of grooves formed on the surface of the active material layer of the negative electrode plate shown in FIG. 3, and FIG. 4B is a diagram showing another example thereof.

FIG. 5A is a schematic cross-sectional view showing a further example of a negative electrode plate according to the present invention, and FIG. 5B is a diagram showing the arrangement of holes formed on the surface of the active material layer.

FIG. 6 is a schematic cross-sectional view showing a still further example of a negative electrode plate according to the present invention.

FIGS. 7A and 7B are cross-sectional views showing the steps of an example of a method for forming a negative electrode plate according to the present invention.

FIGS. 8A to 8C are cross-sectional views showing the steps of another example of a method for forming a negative electrode plate according to the present invention.

FIG. 9 is a partially exploded perspective view schematically showing an example of a nickel-metal hydride storage battery according to the present invention.

FIG. 10 is a schematic cross-sectional view showing the structure of a negative electrode plate of a comparative example.

### DESCRIPTION OF THE PREFERRED EMBODIMENTS

Hereinafter, embodiments of the present invention will be described with reference to the accompanying drawings. In the following description, the same reference numerals will be applied to the same parts, and a redundant explanation may be omitted.

### Embodiment 1

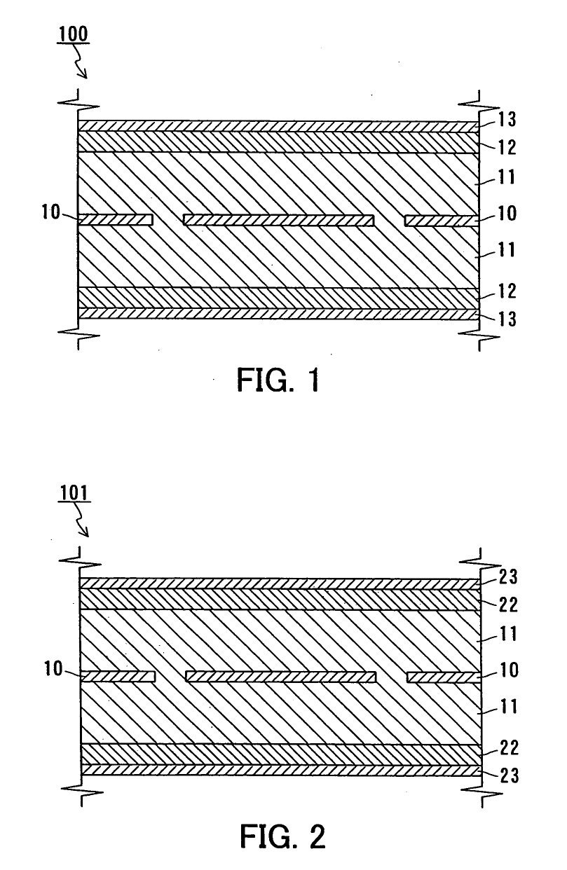

In Embodiment 1, an example of a negative electrode plate according to the present invention will be described. A negative electrode plate of the present invention is for a nickel-metal hydride storage battery. FIG. 1 schematically shows a cross-sectional view of a negative electrode plate 100 of Embodiment 1.

The negative electrode plate 100 includes a conductive support 10, as well as a first layer 11, a second layer 12 and a third layer 13 that are formed successively on both sides of the support 10.

As the support 100, a punched metal made of nickel or a nickel-plated punched metal of steel can be used, for example. FIG. 1 shows a punched metal having a plurality of through holes.

The first layer 11 contains a hydrogen-absorbing alloy and a first powder made of a carbonaceous material. As the hydrogen-absorbing alloy, any alloy commonly used for nickel-metal hydride storage batteries can be used. Examples include an alloy containing Mm (misch metal: a mixture of rare-earth elements) and nickel. Ordinarily, a pulverized hydrogen-absorbing alloy is made of particles having various shapes, so that the contacts between the alloy particles are often point contacts.

As the first powder, a powder of a carbonaceous material (carbonaceous powder), such as carbon black, graphite or coke, can be used. The particle size of the first powder is in the range of 1 μm to 20 μm, and preferably in the range of 5 μm to 10 μm. The range of particle size of a powder defined in the present specification refers to a “substantial range”, meaning a range that covers the particle sizes of substantially all the particles, for example, 90 wt % or more of the particles of a powder. A powder containing a trace amount of particles whose particle sizes fall outside the range of particle size defined herein can be encompassed by the present invention, as long as the effect of the present invention is not impaired.

The second layer 12 contains a hydrogen-absorbing alloy, the above-described first powder and a second powder having conductivity. In the negative electrode plate of Embodiment 1, the second powder is a powder made of a carbonaceous material. The first powder and the second powder can be made of either a same carbonaceous material or different carbonaceous materials. The thickness of the second layer. 12 preferably is 1% to 10% of the overall thickness of the negative electrode plate. As the carbonaceous material, commercially available graphite, natural graphite black, coke or acetylene black can be used. Since graphite particles are capable of absorbing and desorbing hydrogen and have excellent conductivity, the use of graphite powder makes it possible to improve the gas absorption capability and high-rate charge and discharge characteristics of the negative electrode. The particle size of the second powder is 7.0 μm or less (preferably, in the range of 0.05 μm to 4.0 μm). By setting the particle size at 7.0 μm or less, it is possible to facilitate the entry of the particles of the second powder between the hydrogen-absorbing alloy particles.

The third layer 13 contains the above-described second powder and a binder. The thickness of the third layer 13 is 0.3% to 6.0% of the overall thickness of the negative electrode plate. As the binder, polyvinyl alcohol (PVA), polyvinylpyrrolidone (PVP), polyethylene oxide (PEO) or a styrene-butadiene rubber based polymer (SBR) can be used, for example. In general, the first and the second layers 11 and 12 also contain the above-described binder. These layers further may contain a thickener and the like. The thickness of the third layer preferably is 1.0% to 4.0% of the overall thickness of the negative electrode plate.

The amount of the second powder preferably is 0.0001 g or more and 0.002 g or less per cm² of the negative electrode plate. By setting the amount of the carbonaceous powder within this range, it is possible to prevent a large amount of electrolyte from being absorbed by the second powder. The second and the third layers 12 and 13 can be formed by the method that will be described in Embodiment 4.

In the following, the first to the third layers will be described. Each of the first and the second powders contained in the first to the third layers serves as a conductive agent. The first to the third layers have different contents of these conductive powders. The second layer has substantially the same content of the first powder as the first layer, and further contains the second powder. The third layer contains the second powder as the main component (80 wt % or more), and contains no hydrogen-absorbing alloy. Accordingly, the contents (wt %) of the conductive powders increase in the following order: the first layer, the second layer and the third layer. Therefore, the conductivity in the vicinity of the surface is higher in a negative electrode plate of the present invention than in conventional negative electrode plates. This is due to the method for forming the first to the third layers.

The negative electrode plate of Embodiment 1 includes the second layer with higher conductivity on the surface of the first layer 11 and the third layer with the highest conductivity on its outermost surface. Accordingly, the use of this negative electrode plate makes it possible to prevent an excessive increase in the internal pressure of a battery and also to provide a nickel-metal hydride storage battery with excellent high-rate charge and discharge characteristics.

### Embodiment2

In Embodiment 2, another example of a negative electrode plate according to the present invention will be described. FIG. 2 schematically shows a cross-sectional view of a negative electrode plate 101 of Embodiment 2.

The negative electrode plate 101 includes the conductive support 10, as well as the first layer 11, a second layer 22 and a third layer 23 that are formed successively on both sides of the support 10. The support 10 and the first layer 11 are the same as those described in Embodiment 1.

The second layer 22 contains a hydrogen-absorbing alloy, a first powder and a second powder having conductivity. In the negative electrode plate of Embodiment 2, the second powder is a mixed powder of a carbonaceous powder (the second powder of Embodiment 1) and a metal powder. Generally, the second layer 22 further contains a binder. The hydrogen-absorbing alloy, the first powder, the carbonaceous powder and the binder are the same as those described in Embodiment 1. As the metal powder, any metal powder capable of catalyzing the reaction of oxygen gas and hydrogen and having conductivity can be used. Specific examples include a nickel powder, a cobalt powder and a copper powder. The particle size of the metal powder preferably is 7.0 μm or less (more preferably, in the range of 0.05 μm to 4.0 μm). Similarly, the particle size of the carbonaceous powder preferably is 7.0 μm or less (more preferably, in the range of 0.05 μm to 4.0 μm). The thickness of the second layer 22 preferably is 1% to 10% of the overall thickness of the negative electrode plate.

The third layer 23 contains the second powder as the main component (80 wt % or more) and further contains a binder. The second powder is the same as the powder contained in the second layer 22. As the binder, the binder described in Embodiment 1 can be used. The thickness of the third layer 23 preferably is 1.0% to 4.0% of the overall thickness of the negative electrode plate.

The amount of the second powder, that is, the total amount of the metal powder and the carbonaceous powder, preferably is 0.0001 g or more and 0.002 g or less per cm² of the negative electrode plate. The amount of the metal powder is 50 wt % or less of the carbonaceous powder. By setting the amount of the metal powder at 50 wt % or less of the carbonaceous powder, it is possible to prevent an excessive lowering of the hydrogen overvoltage of the negative electrode. The second and the third layers can be formed by the method that will be described in Embodiment 4.

Thus, the second powder is added to the negative electrode plates of Embodiments 1 and 2 from their surfaces to a certain depth. With this structure, it is possible to improve the oxygen consumption capability and high-rate charge and discharge characteristics of the negative electrode plate for the following reason.

In the case of a commonly used negative electrode plate, during charge and discharge, the hydrogen-absorbing alloy is started to be charged and discharged from its portion in the vicinity of the support. For this reason, the portion of the hydrogen-absorbing alloy in the vicinity of the surface of the negative electrode is difficult to be charged and discharged. In contrast, in the case of a negative electrode plate of the present invention, its conductivity on the surface is high due to the presence of the second powder, so that the portion of the hydrogen-absorbing alloy in the vicinity of the surface is easy to be charged and discharged. Accordingly, the reaction of hydrogen in the hydrogen-absorbing alloy and oxygen gas proceeds promptly on the surface of the negative electrode plate from the early period of charge. This results in improved oxygen gas consumption capability. Moreover, since the resistance polarization is small in this negative electrode plate during high-rate charge and discharge, the high-rate charge and discharge characteristics are improved.

Furthermore, in a negative electrode plate of the present invention, a layer made of a carbonaceous material is formed on its outer most surface, so that the hydrogen-absorbing alloy is not exposed on the surface of the negative electrode. Accordingly, it is possible to prevent the oxidation of the hydrogen-absorbing alloy by oxygen gas and the decrease of the battery performance through charge and discharge.

By further adding the above-described metal powder to the second and the third layers, it is possible to improve the oxygen gas consumption capability and the high-rate charge and discharge characteristics.

### Embodiment 3

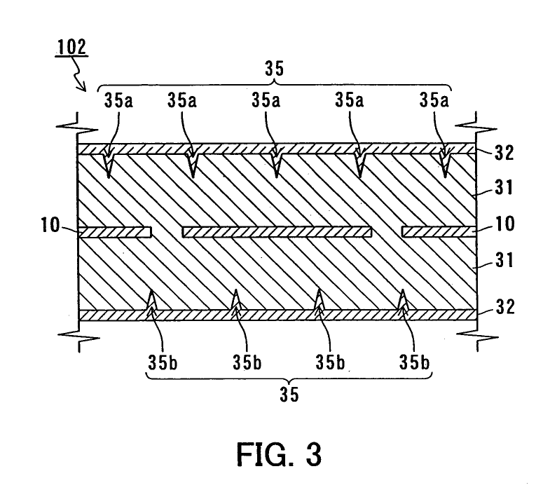

In Embodiment 3, a still another example of a negative electrode plate according to the present invention will be described. FIG. 3 shows a cross-sectional view of a negative electrode plate 102 of Embodiment 3.

The negative electrode plate 102 includes the conductive support 10, as well as an active material layer 31 and a conductive layer 32 that are formed successively on both sides of the support 10.

The support 10 is the same as the one described in Embodiment 1. The active material layer 31 can be formed by the identical materials to those of the first layer 11 described in Embodiment 1, and therefore, redundant descriptions are omitted. The active material layer 31 contains a hydrogen-absorbing alloy as the main component (90 wt % or more). However, the active material layer 31 differs from the first layer 11 in the shape of its surface.

The conductive layer 32 can be formed by the identical materials to those of the third layer 13 described in Embodiment 1, and therefore, redundant descriptions are omitted.

On the surface of the active material layer 31, a plurality of recesses with a depth of 50% or less (preferably, 5% or more and preferably 20% or less) of the thickness of the active material layer 31 is formed. The depth of the recesses is, for example, about 5 μm to about 60 μm. The thickness of the active material layer 31 is, for example, about 100 μm to about 300 μm. In FIG. 3, the recesses are grooves 35.

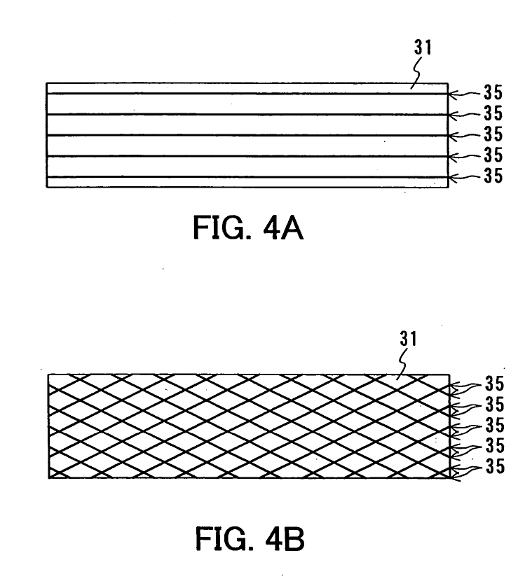

The grooves 35 shown in FIG. 3 are V-grooves. FIG. 4A schematically shows an arrangement of the grooves 35 on the surface of the active material layer 31. A plurality of the grooves 35 is arranged in the form of stripes. As shown in the cross-sectional view in FIG. 3, it is preferable that a groove 35a on one side is formed so as to be placed at a central portion between adjacent grooves 35b on the other side. By arranging the recesses on one side and the recesses on the other side in such a manner that they are not directly opposite to each other as much as possible in this manner, it is possible to prevent the reduction in the strength of the electrode plate.

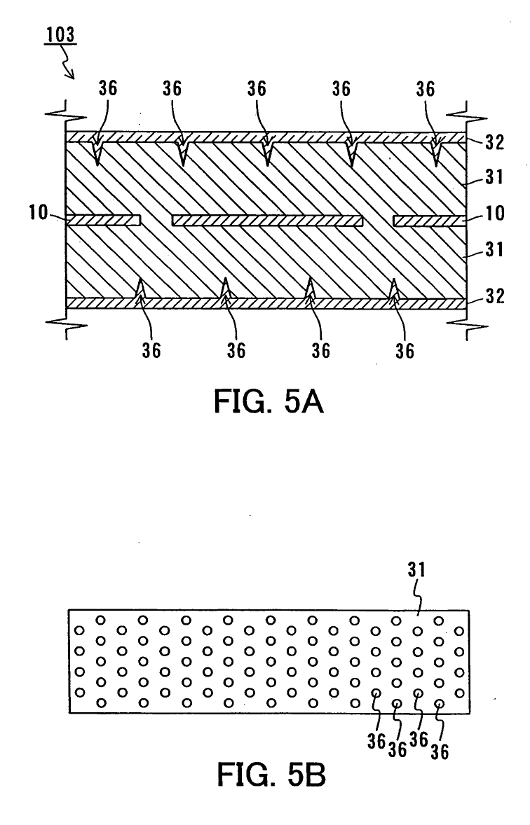

It should be noted that the grooves 35 also may be arranged in the form of a lattice. FIG. 4B schematically shows an example of such an arrangement of the grooves 35. The recesses formed on the active material layer 31 may also be in the form of holes, for example, cone-shaped holes. FIG. 5A shows a cross-sectional view of a negative electrode plate 103 that includes such holes 36. FIG. 5B schematically shows an arrangement of the holes 36. It should be noted that the arrangement of the recesses is not limited to the examples shown in the figures, and may be any arrangement as long as the effect of the present invention can be achieved.

The recesses formed on the active material layer 31 are filled with the conductive layer 32. The thickness of the conductive layer 32 (excluding the recesses) is. 0.2% to 5.0% of the overall thickness of the negative electrode plate.

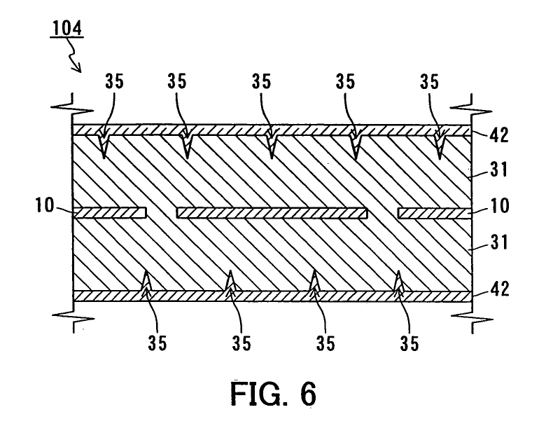

The conductive layer may contain a carbonaceous powder and a metal powder as:the main components. In this case, the conductive layer can be formed by the identical materials to those of the third layer 23 described in Embodiment 2. FIG. 6 shows a cross-sectional view of a negative electrode plate 104 that includes a conductive layer 42 formed by the identical materials to those of the third layer 23.

In the negative electrode plate of Embodiment 3, the recesses are formed on the surface of the active material layer. Since the recesses are filled with the material having high conductivity, the conductivity of the active material layer is higher at its portion on the surface side. Moreover, the surface area of the active material layer is increased due to the presence of the recesses. Consequently, like the negative electrode plates of Embodiments 1 and 2, it is possible to obtain a negative electrode plate with high oxygen gas consumption capability and improved high-rate charge and discharge characteristics. Moreover, since the conductive layer suppresses the oxidation of the hydrogen-absorbing alloy in the active material layer, it is possible to obtain a negative electrode plate with little decrease in performance through charge and discharge.

By further adding the above-described metal powder to the conductive layer, it is possible to improve the oxygen gas consumption capability and the high-rate charge and discharge characteristics.

### Embodiment 4

In Embodiment 4, an example of a method for producing the negative electrode plates described in Embodiments 1 and 2 according to the present invention will be described.

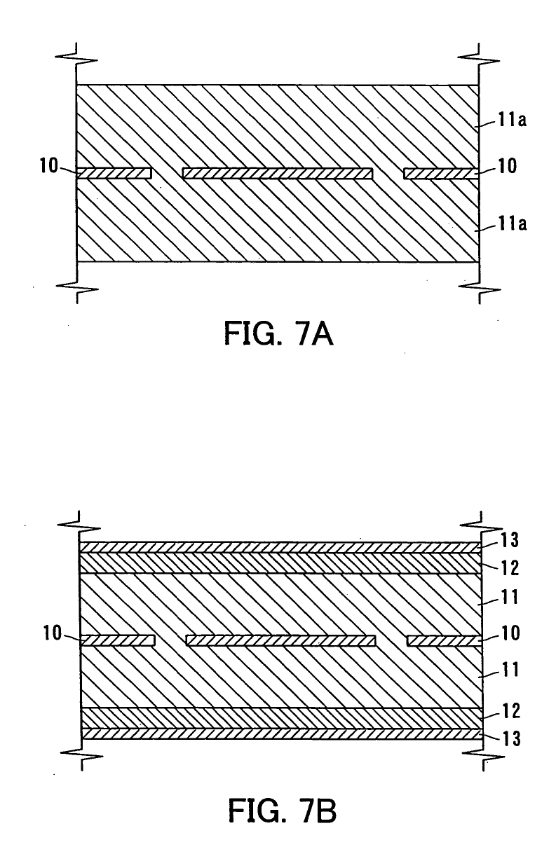

This production method first forms a first layer 11a on the surface of the conductive support 10, as shown in FIG. 7A. Specifically, a first slurry containing a hydrogen-absorbing alloy powder and a first powder made of a carbonaceous material is applied onto both sides of the support 10, followed by drying to form the first layer 11a formed on both sides of the support 10 (step (i)). Apart of the first layer la will become the first layer 11 by a subsequent step. As the methods for the application and the drying, any known methods used for producing negative electrode plates can be employed. For example, the application can be carried out by passing the support (e.g., punched metal) through the slurry and then the drying can be performed in a drying furnace.

The hydrogen-absorbing alloy and the first powder are, respectively, the hydrogen-absorbing alloy and the first powder described in Embodiment 1. The slurry can be formed by mixing materials such as the hydrogen-absorbing alloy, the first powder, a binder and a thickener, with water.

Next, a second slurry containing a second powder is sprayed on the first layer 11a (step (ii)). The second powder is the second powder having conductivity described in Embodiment 1 or Embodiment 2. In the case of producing the negative electrode plate of Embodiment 1, the second powder is a carbonaceous powder. In the case of producing the negative electrode plate of Embodiment 2, the second powder is a mixed powder of a carbonaceous powder and a metal powder.

In general, the second slurry further contains the binder described in Embodiment 1. The second slurry can be formed by mixing materials, such as the second powder and the binder, with water. For example, while moving the first layer 11a, the second slurry is sprayed from a nozzle under pressure onto the first layer 11a.

Thereafter, the second slurry is dried, and then subjected to pressing and cutting, as necessary. Thus, the negative electrode plate 100 as shown in FIG. 7B is formed. The portion of the first layer 11a where the second slurry has entered becomes the second layer 12 (or the second layer 22). The portion of the first layer 11a where the second slurry has not entered becomes the first layer 11. The portion of the first layer 11a where only the second slurry has been deposited on its surface becomes the third layer 13 (or the third layer 23).

The thickness of each of the layers can be adjusted with the amount and spraying pressure of the second slurry sprayed to the first layer. The depth to which the second slurry enters can be controlled with the spraying pressure. The spraying pressure of the slurry is, for example, 0.2 MPa. Thus, the thickness of the second layer to be formed is set within the range of 1% to 10% of the overall thickness of the negative electrode plate. It is preferable that the second slurry is sprayed in such a manner that the amount of the second powder is 0.0001 g or more and 0.002 g or less per cm² of the electrode plate.

With the production method of Embodiment 4, the negative electrode plates described in Embodiments 1 and 2 can be produced readily. In addition, the negative electrode plates of Embodiments 1 and 2 also can be produced by successively applying the first slurry for forming the first layer, the second slurry for forming the second layer and the third slurry for forming the third layer. In this case, the carbonaceous powder contained in the second layer and the carbonaceous powder contained in the third layer may be different.

### Embodiment 5

In Embodiment 5, an example of a method for producing the negative electrode plate described in Embodiment 3 according to the present invention will be described.

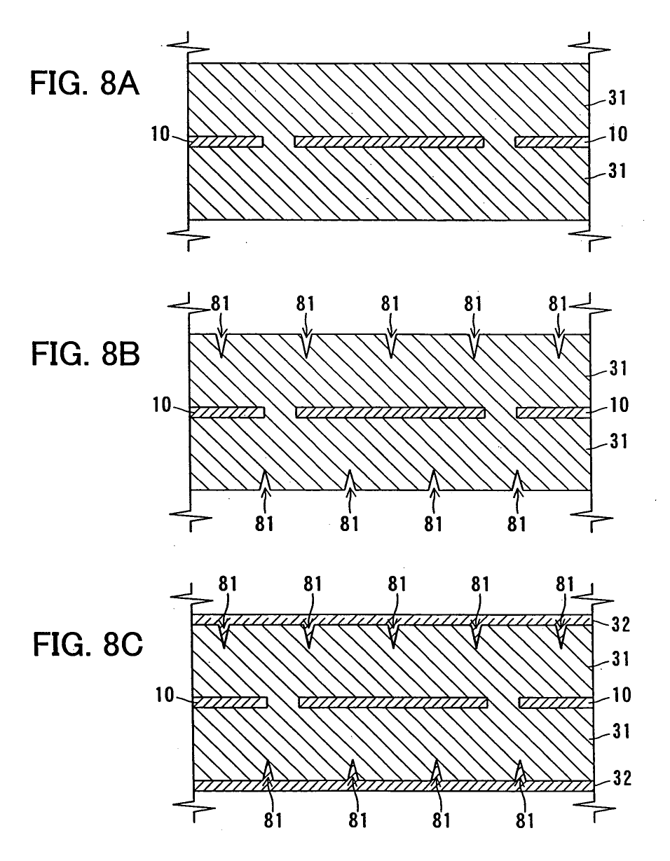

First, as shown in FIG. 8A, the active material layer 31 is formed on both sides of the conductive support 10 by a known method. Specifically, a first slurry containing a hydrogen-absorbing alloy and a first powder made of a carbonaceous material is applied onto both sides of the support 10, followed by drying to form the active material layer 31 (step (I)). Here, pressing may be performed, as necessary, after drying. The first slurry is the same as the first slurry described in Embodiment 4. This step is similar to the step (i) described in Embodiment 4.

Next, as shown in FIG. 8B, a plurality of recesses 81 with a depth of 50% or less (preferably, 5% or more and preferably 20% or less) of the thickness of the active material layer 31 is formed on the surface of the active material layer 31 (step (II)). As described in Embodiment 3, the recesses 81 are V-grooves, cone-shaped holes or the like. The recesses 81 can be formed by pressing the active material layer 31 by means of a press roller provided with projections having a predetermined shape.

In the case of forming V-grooves into the form of stripes, a roller having a plurality of ring-shaped projections formed along its circumference is used. In the case of forming grooves into the form of a lattice, a roller having projections in the form of a lattice formed thereon is used. If the recesses are holes, a roller having a plurality of cone-shaped projections formed on its surface is used.

Next, as shown in FIG. 8C, a second slurry containing a second powder having conductivity is applied onto the active material layer 31 (step (III)). Through this step, the conductive layer 32 having high conductivity is formed. The conductive layer 32 is also filled into the recesses 81 of the active material layer 31.

As the second powder, the second powder described in Embodiment 1 or 2 can be used. That is, the second powder is a carbonaceous powder or a mixed powder of a carbonaceous powder and a metal powder. The second slurry contains the binder described in Embodiment 1. The second slurry can be formed by mixing the second powder, the binder and water. The second slurry can be applied either by a commonly used application method, or by spraying the second slurry.

Thus, the negative electrode plate described in Embodiment 3 can be readily produced.

### Embodiment 6

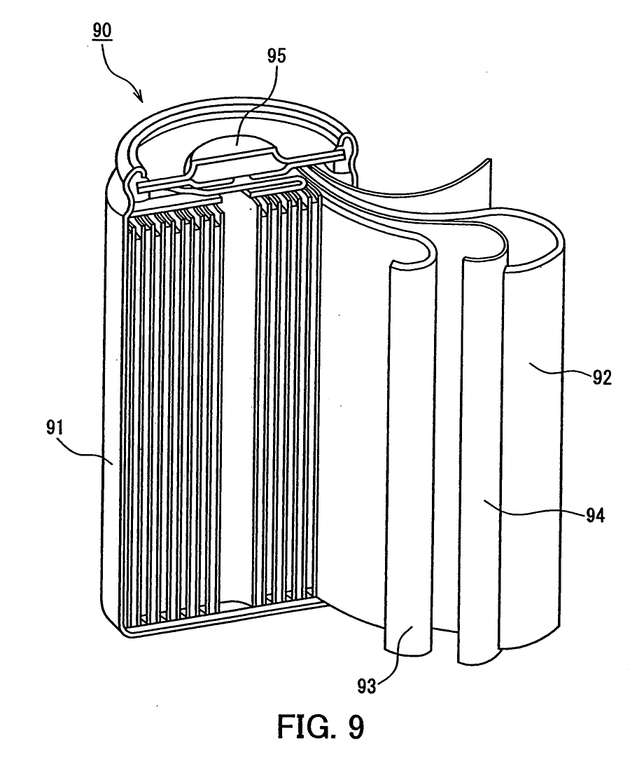

In Embodiment 6, an example of a nickel-metal hydride storage battery according to the present invention will be described. FIG. 9 shows a partially exploded perspective view of a nickel-metal hydride storage battery 90 (hereinafter, occasionally referred to as “battery 90”) of Embodiment 6.

The battery 90 includes a case 91, a negative electrode plate 92, a positive electrode plate 93, a separator 94, an electrolyte (not shown) and a sealing plate 95. The separator 94 is arranged between the negative electrode plate 92 and the positive electrode plate 93. The negative electrode plate 92, the positive electrode plate 93 and the separator 94 are wound in the form of a coil, and sealed in the case 91, together with the electrolyte. The sealing plate 95 is equipped with a safety valve.

As the negative electrode plate 92, any one of the negative electrode plates described in Embodiments 1 to 3 is used. As the case 91, the positive electrode plate 93, the separator 94 and the electrolyte, the ones commonly used for nickel-metal hydride storage batteries can be used.

Since the battery 90 employs a negative electrode plate of the present invention, it is possible to prevent an excessive increase in the internal pressure of the battery during overcharge and large current charge. Moreover, the battery 90 has excellent high-rate (large current) charge and discharge characteristics.

### EXAMPLES

Hereinafter, the present invention will be described more specifically by way of examples.

### Example 1

In Example 1, a negative electrode plate of the present invention was produced, and a nickel-metal hydride storage battery of the present invention was produced using the negative electrode plate.

Sample A

The negative electrode plate was produced as follows. First, a hydrogen-absorbing alloy having a composition represented by MmNi_{3.55}Co_{0.75}Mn_{0.4}Al_{0.3} was prepared, and the hydrogen-absorbing alloy was pulverized in a ball mill, thereby obtaining a powder having an average particle size of 24 μm. Thereafter, 100 parts by weight of the hydrogen-absorbing alloy powder, 0.15 part by weight of carboxymethyl cellulose as a thickener, 0.3 part by weight of carbon black as a conductive agent, 0.8 part by weight of a styrene-butadiene copolymer as a binder and water as a dispersion medium were mixed to form a paste. The paste was applied onto a punched metal serving as a support, followed by drying to obtain a base electrode plate 1.

Next, 95 parts by weight of a natural graphite powder, 5 parts by weight of polyvinyl alcohol as a binder and water as a dispersion medium were mixed to form a slurry. The natural graphite powder had a particle size of 0.2 μm to 3.0 μm and an average particle size of 2.0 μm. Then, the obtained slurry was sprayed under pressure onto both sides of the base electrode plate 1. For the spraying of the slurry, a two-fluid nozzle was used. The slurry was sprayed in such a manner that the amount of the natural graphite powder was 0.001 g per cm² of the electrode plate.

Thereafter, the electrode plate was dried and pressed, followed by cutting, into a thickness of 0.33 mm, a width of 3.5 cm and a length of 31 cm, thereby producing a negative electrode plate of the present invention (hereinafter, occasionally referred to as “negative electrode plate A”). The cross-sectional view of the obtained negative electrode plate A was like that schematically shown in FIG. 1.

Element distribution analysis using an electron probe microanalysis (EPMA) was performed on the cross-section of the negative electrode plate A. As a result, a layer containing a hydrogen-absorbing alloy and a graphite powder (the second layer 12) was observed in the vicinity of the surface of the negative electrode plate A, and a layer made of graphite particles (the third layer 13) was observed on the outermost surface.

Next, using the negative electrode plate A, the nickel-metal hydride storage battery shown in FIG. 9 was produced. First, the negative electrode plate A was combined with a positive electrode plate and a separator, and the whole was spirally wound to construct an electrode assembly. Then, each of the positive electrode plate and the negative electrode plate was provided with a current collector. Here, as the positive electrode plate, a commonly used paste type nickel positive electrode plate (width of 3.5 cm, length of 26 cm and thickness of 0.57 mm) was used. As the separator, a nonwoven fabric made of polypropylene to which a hydrophilic group had been imparted was used. Then, the electrode assembly and an electrolyte were housed in an SC size battery case. A potassium hydroxide aqueous solution with a specific gravity of 1.30 in which lithium hydroxide was dissolved at 40g/L was used as the electrolyte.

Thereafter, the top of the case was sealed with a sealing plate. Thus, a nickel-metal hydride storage battery of the present invention having a nominal capacity of 3000 mAh (hereinafter, occasionally referred to as “sample A”) was produced.

Sample B

Next, a negative electrode plate was produced in the same manner as the sample A, except that the slurry sprayed onto the surface of the negative electrode plate was different. Specifically, a slurry different from that used for the sample A was sprayed onto the base electrode plate 1 (the electrode plate before being sprayed with the slurry) described in the section on the sample A. The slurry was produced by mixing 66.5 parts by weight of a natural graphite powder, 28.5 parts by weight of a metallic nickel powder, 5 parts by weight of polyvinyl alcohol as a binder and water as a dispersion medium. Here, the amount of the metallic nickel powder was set at 30 wt % with respect to that of the graphite powder. The natural graphite powder had a particle size of 0.2 μm to 3.0 μm and an average particle size of 2.0 μm. The nickel powder had a particle size of 1.0 μm to 4.0 μm and an average particle size of 2.0 μm. The slurry was sprayed in such a manner that the total amount of the graphite powder and the metallic nickel powder was 0.001 g per cm² of the electrode plate.

The electrode plate thus obtained was dried, pressed and cut, thereby obtaining a negative electrode plate of the present invention (hereinafter, occasionally referred to as “negative electrode plate B”). The cross-sectional view of the negative electrode plate B was like that schematically shown in FIG. 2.

EPMA element distribution analysis was performed on the cross-section of the negative electrode plate B. As a result, a layer containing a hydrogen-absorbing alloy, graphite particles and nickel particles (the second layer 22) was observed in the vicinity of the surface of the negative electrode plate, and a layer containing graphite particles and nickel particles (the third layer 23) was observed on the outermost surface.

Except for using the negative electrode plate B thus obtained, a battery (hereinafter, occasionally referred to as “battery B”) was produced in the same manner as the sample A.

Comparative Sample C

Next, a nickel-metal hydride storage battery was produced in the same manner as the sample A, except that the negative electrode plate was different.

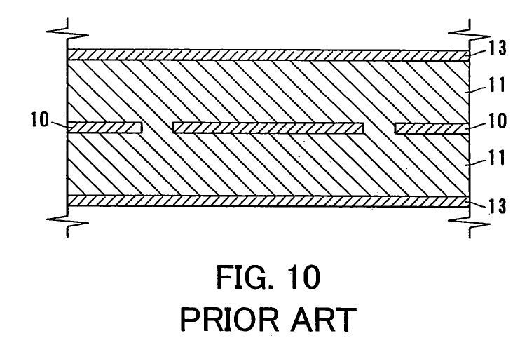

The negative electrode plate was produced in the following manner. First, the base electrode 1 (the electrode plate before being sprayed with the slurry) described in the section on the sample A was produced, and the base electrode 1 was pressed. Thereafter, the slurry containing a natural graphite powder that was described in the section on the sample A was applied onto both sides of the base electrode plate 1, dried, pressed and cut, thereby obtaining a negative electrode plate. The application of the slurry was performed by a commonly used spraying method using a two-fluid nozzle. FIG. 10 schematically shows a cross-sectional view of the negative electrode plate. As shown in FIG. 10, the first layer 11 and the third layer 13 were laminated on the support 10.

Except for using the negative electrode plate obtained in the above-described manner, a battery (hereinafter, occasionally referred to as “comparative sample C”) was produced in the same manner as the sample A.

Comparative Sample D

Next, a nickel-metal hydride storage battery was produced in the same manner as the sample A, except that the negative electrode plate was different.

The negative electrode plate was produced in the following manner. First, a hydrogen-absorbing alloy was pulverized with a pulverizer to form alloy particles (core particles). Next, natural graphite particles having a particle size of 0.2 μm to 3.0 μm and an average particle size of 2.0 μm were strongly bonded to the surface of the alloy particles. Specifically, the graphite particles were electrostatically adhered to the surface of the alloy particles, and then impact was given to the particles by rotating the particles (powder) in a rotating drum. Consequently, the graphite particles were driven into the-surface of the alloy particles, and the graphite particles were strongly bonded to the surface of the alloy particles.

By using the alloy powder thus obtained, a paste was produced in the manner described in the section on the sample A. Meanwhile, the base electrode plate 1 (the electrode plate before being sprayed with the slurry) described in the section on the sample A was produced and pressed. The above-mentioned paste was applied onto both sides of the base electrode plate 1, dried, pressed and cut, thereby obtaining a negative electrode plate D. The negative electrode plate D had a laminated structure similar to that of the negative electrode plate shown in FIG. 10. In the case of the negative electrode plate D, the third layer 13 was formed by the above-mentioned paste.

Except for using the negative electrode plate thus obtained, a battery (hereinafter, occasionally referred to as “comparative sample D”) was produced in the same manner as the sample A.

Evaluation of Battery Performance

After assembling the above-mentioned four types of batteries, these batteries were stored at 25° C. for one day. Thereafter, each battery was charged with a current of 300 mA at 20° C. for 15 hours, then discharged with a current of 600 mA until the terminal voltage of the battery reached 1.0 V Then, this charge/discharge cycle was repeated once again. Thus, the produced batteries were activated. The resulting batteries were evaluated for the internal pressure characteristics during overcharge and the high-rate discharge characteristics.

The internal pressure characteristics during overcharge were evaluated by charging each battery with a current of 3000 mA at 20° C. for 1.2 hours and measuring the internal pressure of the charged battery. On the other hand, the high-rate discharge characteristics were evaluated in the following manner. First, each battery was subjected to 10 charge/discharge cycles, in each of which the battery was charged with a current of 3000 mA at 20° C. for 1.2 hours and then discharged with a current of 3000 mA until the terminal voltage of the battery reached 1.0 V. Thereafter, the battery was charged with a current of 3000 mA at 20° C. for 1.2 hours and then discharged with a current of 30 A until the terminal voltage of the battery reached 0.8 V. The average discharge voltage during this large current discharge was determined. Additionally, taking as 100% the discharge capacity when the battery was charged with a current of 3000 mA at 20° C. for 1.2 hours and then discharged with a current of 600 mA until the battery voltage reached 1.0 V, the ratio of the discharge capacity during large current discharge to the above-mentioned discharge capacity was determined. Table 1 shows the batteries' internal pressure during overcharge, discharge capacity ratio during large current discharge and average discharge voltage during large current discharge.

TABLE 1

| | | Discharge capacity | Average discharge |
|---|---|---|---|
| | | ratio during | voltage during |
| | Internal | large current | large current |
| | pressure | discharge | discharge |
| Battery | [MPa] | [%] | [V] |
| Sample A | 0.62 | 90 | 1.03 |
| Sample B | 0.65 | 93 | 1.06 |
| Com. sample C | 0.88 | 75 | 0.90 |
| Com. sample D | 0.93 | 70 | 0.87 |

As is clear from Table 1, the increase in the internal pressure during overcharge was more suppressed in the samples A and B of the present invention than in the comparative samples C and D. Moreover, the discharge capacity ratio and discharge voltage during large current discharge were higher in the samples A and B than in the comparative samples C and D.

The high performance of the samples A and B is due to the effects described in the embodiments. In contrast, since the graphite powder layer was formed only on the outermost surface of the electrode plate in the case of the comparative sample C, the conductivity was improved on the surface of the negative electrode plate, but not in the remaining portions. Therefore, the comparative sample C was insufficient in terms of both the oxygen gas consumption capability and the large current charge and discharge characteristics. In the case of the comparative sample D, since the graphite particles bonded to the surface of the hydrogen-absorbing alloy had lower conductivity than the alloy, the contacts between the hydrogen-absorbing alloy particles were inhibited, thereby resulting in a decrease in the conductivity of the electrode. Consequently, the comparative sample D was insufficient in terms of both the oxygen gas consumption capability and the large current charge and discharge characteristics.

### Example 2

In this example, a negative electrode plate was produced in the same manner as the negative electrode plate A of the sample A, except that the amount of the graphite powder applied to the base electrode plate 1 was different. Specifically, as shown in Table 2, negative electrode plates E1 to E7 were produced by varying the amount of the graphite powder sprayed to the active material layer. Thereafter, seven types of batteries (samples E1 to E7) were produced in the same manner as the sample A, except for using the negative electrode plates E1 to E7, respectively. Here, the sample E5 is the same as the sample A. These batteries were activated in the same manner as in Example 1. Then, the performance of the resulting batteries was evaluated in the same manner as in Example 1. The evaluation results are shown in Table 2. Each of the applied amounts shown in the table indicates the amount applied to both sides of 1 cm² of the negative electrode plate.

TABLE 2

| | | | Discharge | Average |
|---|---|---|---|---|
| | | | capacity | discharge |
| | Applied amount | | ratio during | voltage during |
| | of | Internal | large current | large current |
| | graphite powder | pressure | discharge | discharge |
| Battery | [g/cm²] | [MPa] | [%] | [V] |
| Sample E1 | 0.00005 | 0.90 | 73 | 0.88 |
| Sample E2 | 0.0001 | 0.71 | 81 | 0.98 |
| Sample E3 | 0.0002 | 0.65 | 83 | 1.01 |
| Sample E4 | 0.0005 | 0.64 | 87 | 1.02 |
| Sample E5 | 0.001 | 0.62 | 90 | 1.03 |
| Sample E6 | 0.002 | 0.60 | 88 | 1.01 |
| Sample E7 | 0.003 | 0.58 | 72 | 0.90 |

As shown in Table 2, the internal pressure of the batteries decreased with an increase in the applied amount of the graphite powder. This is because the oxygen gas consumption reaction was promoted on the surface of the negative electrode. However, the discharge capacity ratio and discharge voltage during large current discharge decreased when the applied amount was 0.003 g/cm². This is presumably because the increased applied amount resulted in an increase in the amount of the electrolyte absorbed by the negative electrode. When the amount of the electrolyte absorbed by the negative electrode increases, the amount of the electrolyte retained in the separator decreases, increasing the internal resistance of the battery. This is believed to be the reason for the decrease in the large current discharge characteristics. In view of the results obtained in Example 2, it is desirable that the applied amount of the graphite be 0.0001 g to 0.002 g per cm² of the electrode plate.

### Example 3

In this example, a negative electrode plate was produced in the same manner as the negative electrode plate B of the sample B, except that the amounts of the graphite powder and the nickel powder applied to the base electrode plate 1 were different. Specifically, as shown in Table 3, negative electrode plates F1 to F7 were produced by varying the amounts of the graphite powder and the nickel powder sprayed on the base electrode plate 1. Here, the amount of the nickel powder was set at 30 wt % with respect to that of the graphite powder. Thereafter, seven types of batteries (samples F1 to F7) were produced in the same manner as the sample A, except for using the negative electrode plates F1 to F7, respectively. Here, the sample F5 was the same as the sample B. These batteries were activated in the same manner as in Example 1. Then, the performances of the resulting batteries were evaluated in the same manner as in Example 1. The evaluation results are shown in Table 3.

TABLE 3

| | Total applied | | Discharge | Average |
|---|---|---|---|---|
| | amount of | | capacity | discharge |
| | graphite powder | | ratio during | voltage during |
| | and | Internal | large current | large current |
| | nickel powder | pressure | discharge | discharge |
| Battery | [g/cm²] | [MPa] | [%] | [V] |
| Sample F1 | 0.00005 | 0.95 | 74 | 0.90 |
| Sample F2 | 0.0001 | 0.76 | 85 | 1.01 |
| Sample F3 | 0.0002 | 0.70 | 87 | 1.03 |
| Sample F4 | 0.0005 | 0.67 | 90 | 1.04 |
| Sample F5 | 0.001 | 0.65 | 93 | 1.06 |
| Sample F6 | 0.002 | 0.62 | 90 | 1.03 |
| Sample F7 | 0.003 | 0.58 | 78 | 0.88 |

As shown in Table 3, the internal pressure of the batteries decreased with an increase in the applied amount of the conductive powder (carbon powder and metal powder). This is because the oxygen gas consumption reaction was promoted on the surface of the negative electrode. However, the discharge capacity ratio and discharge voltage during large current discharge decreased when the applied amount was 0.003 g/cm². The reason is presumably the same as that described in Example 2. In view of the results obtained in Example 3, it is desirable that the applied amount of a mixed powder of the carbon powder and the metal powder be 0.0001 g to 0.002 g per cm² of the electrode plate.

### Example 4

In Example 4 a negative electrode plate of the present invention was produced, and another nickel-metal hydride storage battery of the present invention was produced using the negative electrode plate.

Sample G

The negative electrode plate shown in FIG. 3 was produced as follows. First, a hydrogen-absorbing alloy having a composition represented by MmNi_{3.55}Co_{0.75}Mn_{0.4}Al_{0.3} was prepared, and the hydrogen-absorbing alloy was pulverized in a ball mill, thereby obtaining a powder having an average particle size of 24 μm. Thereafter, 100 parts by weight of the hydrogen-absorbing alloy powder, 0.15 part by weight of carboxymethyl cellulose as a thickener, 0.3 part by weight of carbon black as a conductive agent, 0.8 part by weight of a styrene-butadiene copolymer as a binder and water as a dispersion medium were mixed to produce a paste. The paste was applied onto a punched metal (thickness: 0.06 mm) serving as a support, followed by drying to form an active material layer. Thus, a base electrode plate 2 was formed.

Next, the base electrode plate 2 was pressed using a roll presser. At this time, the pressing was performed by means of a roller having a plurality of projections with a V-shaped cross section formed in the direction of its circumference. Through this pressing, the thickness of the base electrode plate was set at 0.32 mm, and the thickness of one active material layer at 0.13 mm. In addition, through this pressing, grooves in the form of stripes as shown in FIG. 4A were formed on both sides of the base electrode plate. The thus formed grooves had a depth of 0.02 mm and a width of 0.05 mm. The interval between adjacent grooves was 1 mm. The grooves on one side were displaced from the groove on the other side by 0.5 mm such that the grooves on one side and the grooves on the other side were spaced apart from one another. FIGS. 3 and 4A schematically show the arrangement of the grooves at this time.

The effect achieved by a negative electrode plate of the present invention is affected by the shape of the grooves. For example, it is affected by the ratio of the depth of the grooves to the thickness of the active material layer. If the depth of the groove is too small relative to the thickness of the active material layer, the effect achieved by the present invention is reduced. On the other hand, if the depth of the grooves is too large relative to the thickness of the active material layer, the density of the hydrogen-absorbing alloy layer excessively increases, thereby resulting in a decrease in the oxygen gas consumption capability of the negative electrode.

Next, a conductive layer was formed on the surface of the active material layer. First, 95 parts by weight of a natural graphite powder, 5 parts by weight of polyvinyl alcohol as a binder and water as a dispersion medium were mixed to produce a slurry. The natural graphite powder had a particle size of 0.2 μm to 3.0 μm and an average particle size of 2.0 μm. Then, the slurry was applied onto both sides of the active material layer. The slurry was applied in such a manner that the amount of the natural graphite was 0.001 g per cm² of the electrode plate.

Finally, the electrode plate was dried, rolled and cut, thereby producing a negative electrode plate having a thickness of 0.33 mm, a width of 3.5 cm and a length of 31 cm. Thus, the negative electrode plate of the present invention shown in FIG. 3 (hereinafter, occasionally referred to as “negative electrode plate G”) was produced. Then, except for using the negative electrode plate G, a battery having a nominal capacity of 3000 mAh (hereinafter, occasionally referred to as “sample G”) was produced in the same manner as the sample A.

Sample H

First, a negative electrode plate H of the present invention was produced in the same manner as the negative electrode plate G, except that the arrangement of the grooves formed on the surface of the active material layer was different. Grooves in the form of a lattice were formed on the active material layer of the negative electrode plate H, as shown in FIG. 4B. Next, except for using the negative electrode plate H, a battery (hereinafter, occasionally referred to as “sample H”) was produced in the same manner as the sample A.

Sample I

First, a negative electrode plate was produced in the same manner as the negative electrode plate G, except that the slurry applied onto the surface of the active material layer was different. The slurry was produced by mixing 66.5 parts by weight of a natural graphite powder, 28.5 parts by weight of a metallic nickel powder, 5 parts by weight of polyvinyl alcohol as a binder and water as a dispersion medium. Here, the amount of the metallic nickel powder was set at 30 wt % with respect to that of the graphite powder. The graphite powder had a particle size of 0.2 μm to 3.0 μm and an average particle size of 2.0 μm. The nickel powder had a particle size of 1.0 μm to 4.0 μm and an average particle size of 2.0 μm. The slurry was applied to the active material layer described in the section on the sample G on which the grooves in the forms of stripes were formed. The slurry was applied in such a manner that the total amount of the natural graphite and the metallic nickel was 0.001 g per cm² of the electrode plate.

The electrode plate thus obtained was dried, pressed and cut, thereby obtaining a negative electrode plate I shown in FIG. 3. Next, except for using this negative electrode plate, a battery (hereinafter, occasionally referred to as “sample I”) was produced in the same manner as the sample A.

Sample J

A negative electrode plate was produced in the same manner as the negative electrode plate G, except that the shape of the recesses formed on the surface of the active material layer was different. First, the base electrode plate 2 described in the section on the sample G was produced. Next, the base electrode plate was pressed using a roll presser. At this time, the pressing was performed by means of a roller having a plurality of cone-shaped projections formed on its surface. Through this pressing, the thickness of the base electrode plate was set at 0.32 mm, and a plurality of cone-shaped holes was formed on both sides of the base electrode plate. The thus formed holes had a depth of 0.02 mm and an opening diameter of 0.05 mm. The interval between adjacent holes was 1 mm. The holes on one side were displaced from the holes on the other side by 0.5 mm such that the holes on one side and the holes on the other side were spaced apart from one another. Thus, the negative electrode plate shown in FIGS. 5A and 5B was obtained.

The effect achieved by the negative electrode plate of the present invention is affected by the shape of the holes. For example, it is affected by the ratio of the depth of the holes to the thickness of the active material layer. If the depth of the holes is too small relative to the thickness of the active material layer, the effect achieved by the present invention is reduced. On the other hand, if the depth of the holes is too large relative to the thickness of the active material layer, the density of the hydrogen-absorbing alloy layer is excessively increased, thereby resulting in a decrease in the oxygen gas consumption capability of the negative electrode.

Next, a conductive layer was produced on the surface of the active material layer. First, 95 parts by weight of a natural graphite powder, 5 parts by weight of polyvinyl alcohol as a binder and water as a dispersion medium were mixed to form a slurry. The natural graphite powder had a particle size of 0.2 μm to 3.0 μm and an average particle size of 2.0 μm. Then, the slurry was applied onto both sides of the active material layer. The slurry was applied in such a manner that the applied amount of the natural graphite was 0.001 g per cm² of the electrode plate.

Finally, the electrode plate was dried, pressed and cut, thereby producing a negative electrode plate having a thickness of 0.33 mm, a width of 3.5 cm and a length of 31 cm. Thus, a negative electrode plate J of the present invention shown in FIGS. 5A and 5B was produced. Then, except for using the negative electrode plate J, a battery (hereinafter, occasionally referred to as “sample J”) was produced in the same manner as the sample A.

Sample K.

A negative electrode plate was produced in the same manner as the negative electrode plate J, except that the slurry applied to the active material layer was different. First, the base electrode plate 2 described in the section on the sample G was produced. Next, a plurality of recesses was formed on the surface of the active material layer in the same manner as the negative electrode plate J. The shape and arrangement of the recesses were the same as those of the negative electrode plate F.

Then, a conductive layer was formed on the surface of the active material layer. A slurry was produced by mixing 66.5 parts by weight of a natural graphite powder, 28.5 parts by weight of a metallic nickel powder, 5 parts by weight of polyvinyl alcohol as a binder and water as a dispersion medium. The natural graphite powder had a particle size of 0.2 μm to 3.0 μm and an average particle size of 2.0 μm. The metallic nickel powder had a particle size of 1.0 μm to 4.0 μm and an average particle size of 2.0 μm. The amount of the-metallic nickel powder was set at 30 wt % with respect to that of the graphite powder. The slurry was applied to both sides of the above-described active material layer. The slurry was applied in such a manner that the total amount of the natural graphite and the metallic nickel was 0.001 g per cm² of the electrode plate.

Thereafter, the electrode plate was dried, pressed and cut, thereby obtaining a negative electrode plate K. Thus, the negative electrode plate of the present invention shown in FIGS. 5A and 5B were produced. Then, except for using the negative electrode plate K, a battery (hereinafter, occasionally referred to “sample K”) was produced in the same manner as the sample A.

Comparative Sample L

A negative electrode plate that was in the state before forming the conductive layer thereon in the production process of the negative electrode plate G of the sample G was formed. This negative electrode plate differs from the negative electrode plate shown in FIG. 3 only in that it includes no conductive layer. Except for using this negative electrode plate, a battery (hereinafter, occasionally referred to as “comparative sample L”) was produced in the same manner as the sample A.

Comparative Sample M

A negative electrode plate that was in the state before forming the conductive layer thereon in the production process of the negative electrode plate J of the sample J was formed. This negative electrode plate differs from the negative electrode plate shown in FIG. 5A only in that it includes no conductive layer. Except for using this negative electrode plate, a battery (hereinafter, occasionally referred to as “comparative sample M”) was produced in the same manner as the sample A.

Evaluation of Battery Performance

After assembling the above-mentioned seven types of batteries, the batteries were activated in the same manner as in Example 1. The performance of the resulting batteries was evaluated in the same manner as in Example 1. Table 4 shows the batteries' internal pressure during overcharge, discharge capacity ratio during large current discharge and average discharge voltage during large current discharge.

TABLE 4

| | | Discharge capacity | Average discharge |
|---|---|---|---|
| | | ratio during | voltage during |
| | Internal | large current | large current |
| | pressure | discharge | discharge |
| Battery | [MPa] | [%] | [V] |
| Sample G | 0.53 | 87 | 1.01 |
| Sample H | 0.51 | 88 | 1.02 |
| Sample I | 0.57 | 89 | 1.03 |
| Sample J | 0.61 | 85 | 1.01 |
| Sample K | 0.62 | 88 | 1.03 |
| Com. sample L | 0.92 | 71 | 0.88 |
| Com. sample M | 0.93 | 71 | 0.87 |

As is clear from Table 4, the increase in the internal pressure of the batteries during overcharge was more suppressed in the samples G, H and I than in the comparative sample L. Moreover, the discharge capacity ratio and discharge voltage-during large current discharge were higher in the samples G, H and I than in the comparative sample L.

Further, as is clear from Table 4, the increase in the internal pressure during overcharge was more suppressed in the samples J and K than in the comparative sample M. Moreover, the discharge capacity ratio and discharge voltage during large current discharge were higher in the samples J and K than in the comparative sample M.

The high performance of the samples G to K is due to the effect described in Embodiment 3. In contrast, since the active material layer was not formed on the surface of the negative electrode in the case of the comparative samples L and M, the conductivity was low in the vicinity of the surface of the negative electrode. Therefore, the comparative samples L and M were insufficient in terms of the oxygen gas consumption capability and the large current charge and discharge characteristics.

### Example 5

In this example, a negative electrode plate was produced in the same manner as the negative electrode plate G of the sample G, except that the amount of the graphite powder applied when forming the conductive layer was different. Specifically, negative electrode plates N1 to N7 were produced by varying the amount of the graphite powder applied to the active material layer, as shown in Table 5. Thereafter, seven types of batteries (samples N1 to N7) were produced in the same manner as the sample G, except for using the negative electrode plates N1 to N7, respectively. Here, the sample N5 is the same as the sample G. These batteries were activated in the same manner as in Example 1. Then, the performance of the resulting batteries was evaluated in the same manner as in Example 1. The evaluation results are shown in Table 5.

TABLE 5

| | | | Discharge capacity | Average discharge |
|---|---|---|---|---|
| | | | ratio during | voltage during |
| | Applied amount of | Internal | large current | large current |
| | graphite powder | pressure | discharge | discharge |
| Battery | [g/cm²] | [MPa] | [%] | [V] |
| Sample N1 | 0.00005 | 0.88 | 72 | 0.90 |
| Sample N2 | 0.0001 | 0.65 | 81 | 0.98 |
| Sample N3 | 0.0002 | 0.57 | 82 | 1.00 |
| Sample N4 | 0.0005 | 0.55 | 85 | 1.01 |
| Sample N5 | 0.001 | 0.53 | 87 | 1.01 |
| Sample N6 | 0.002 | 0.52 | 84 | 0.99 |
| Sample N7 | 0.003 | 0.49 | 71 | 0.89 |

As shown in Table 5, the internal pressure of the batteries decreased with an increase in the applied amount of the graphite powder. This is because the oxygen gas consumption reaction was promoted on the surface of the negative electrode. However, the discharge capacity ratio and discharge voltage during large current discharge decreased when the applied amount was 0.003 g/cm². This is presumably because the increase of the applied amount resulted in an increase in the amount of the electrolyte absorbed by the negative electrode. When the amount of the electrolyte absorbed by the negative electrode increases, the amount of the electrolyte retained in the separator decreases, increasing the internal resistance of the battery. This is believed to be the reason for the decrease in the large current discharge characteristics.

The result obtained in Example 2 shows that it is desirable that the applied amount of the graphite powder be 0.0001 g to 0.002 g per cm² of the electrode plate.

### Example 6

In this example, a negative electrode plate was produced in the same manner as the negative electrode plate I of the sample I, except that the amounts of the graphite powder and the nickel powder applied when forming the conductive layer were different. Specifically, negative electrode plates P1 to P7 were produced by varying the amounts of the graphite powder and the nickel powder applied to the active material layer, as shown in Table 6. Thereafter, seven types of batteries (samples P1 to P7) were produced in the same manner as the sample A, except for using the negative electrode plates P1 to P7, respectively. Here, the sample P5 is the same as the sample I. These batteries were activated in the same manner as in Example 1. Then, the performance of the resulting batteries was evaluated in the same manner as in Example 1. The evaluation results are shown in Table 6.

TABLE 6

| | Total applied | | Discharge | Average |
|---|---|---|---|---|
| | amount of | | capacity | discharge |
| | graphite powder | | ratio during | voltage during |
| | and | Internal | large current | large current |
| | nickel powder | pressure | discharge | discharge |
| Battery | [g/cm²] | [MPa] | [%] | [V] |
| Sample P1 | 0.00005 | 0.89 | 71 | 0.91 |
| Sample P2 | 0.0001 | 0.68 | 81 | 1.00 |
| Sample P3 | 0.0002 | 0.63 | 83 | 1.01 |
| Sample P4 | 0.0005 | 0.60 | 85 | 1.01 |
| Sample P5 | 0.001 | 0.57 | 89 | 1.03 |
| Sample P6 | 0.002 | 0.55 | 85 | 1.00 |
| Sample P7 | 0.003 | 0.51 | 73 | 0.87 |

As shown in Table 6, the internal pressure of the batteries decreased with an increase in the total applied amount of the graphite powder and the metal powder. This is because the oxygen gas consumption reaction was promoted on the surface of the negative electrode. However, the discharge characteristics during large current discharge decreased when the applied amount was 0.003 g/cm². This is believed to be due to the same reason as that described in Example 5.

The result obtained in Example 6 shows that it is desirable that the total applied amount of the graphite powder and the metal powder be 0.0001 g to 0.002 g per cm² of the electrode plate.

It should be noted that although a natural graphite powder was used as the carbonaceous powder, a similar result also can be achieved by using other carbonaceous powder. In addition, a similar effect can also be achieved by using other metal powder such as a cobalt powder or a copper powder, in place of a nickel powder.

Although grooves in the form of stripes or grooves in the form of a lattice were formed in the above-described examples, a similar effect also can be achieved by forming grooves in other arrangement.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1-8. (canceled)

9. A negative electrode plate for a nickel-metal hydride storage battery, comprising a conductive support and an active material layer formed on both sides of the support, wherein
the active material layer contains a hydrogen-absorbing alloy powder as a main component,
a plurality of recesses is formed on a surface of the active material layer and
a conductive layer containing a conductive powder as a main component is provided so as to cover the surface of the active material layer and to fill in the recesses.

10. The negative electrode plate for a nickel-metal hydride storage battery according to claim 9, wherein the conductive powder is a powder essentially made of a carbonaceous material.

11. The negative electrode plate for a nickel-metal hydride storage battery according to claim 9, wherein the conductive powder is a mixed powder of a powder essentially made of a carbonaceous material and a metal powder.

12. The negative electrode plate for a nickel-metal hydride storage battery according to claim 9, wherein the recesses are V-grooves.

13. The negative electrode plate for a nickel-metal hydride storage battery according to claim 12, wherein the grooves on one side and the grooves on the other side are arranged so as not to be directly opposite to each other.

14. The negative electrode plate for a nickel-metal hydride storage battery according to claim 9, wherein the recesses are cone-shaped holes.

15. The negative electrode plate for a nickel-metal hydride storage battery according to claim 14, wherein the holes on one side and the holes on the other side are arranged so as not to be directly opposite to each other.

16. The negative electrode plate for a nickel-metal hydride storage battery according to claim 9, wherein an amount of the conductive powder is 0.0001 g or more and 0.002 g or less per cm² of the negative electrode plate.

17. The negative electrode plate for a nickel-metal hydride storage battery according to claim 9, wherein particle sizes of the conductive powder are in the range of 0.05 μm to 7.0 μm.

18. (canceled)

19. A nickel-metal hydride storage battery comprising a negative electrode plate containing a hydrogen-absorbing alloy, wherein
the negative electrode plate is the negative electrode plate according to claim 9.

20-23. (canceled)

24. A method for producing a negative electrode plate for a nickel-metal hydride storage battery, comprising:
(I) applying a first slurry containing a hydrogen-absorbing alloy powder and a first powder essentially made of a carbonaceous material to both sides of a conductive support, followed by drying to form an active material layer on both sides of the support;
(II) forming a plurality of recesses on a surface of the active material layer; and
(III) applying a second slurry containing a second powder having conductivity to the active material layer.

25. The method for producing a negative electrode plate for a nickel-metal hydride storage battery according to claim 24, wherein the second powder is a powder essentially made of a carbonaceous material.

26. The method for producing a negative electrode plate for a nickel-metal hydride storage battery according to claim 24, wherein the second powder is a mixed powder of a powder essentially made of a carbonaceous material and a metal powder.

27. The method for producing a negative electrode plate for a nickel-metal hydride storage battery according to claim 24, wherein particle sizes of particles constituting the first powder are in the range of 1 μm to 20 μm and particle sizes of particles constituting the second powder are in the range of 0.05 μm to 7.0 μm.

28. The method for producing a negative electrode plate for a nickel-metal hydride storage battery according to claim 24, wherein the recesses are V-grooves.
